(19) United States
(12) Patent Application Publication
(10) Pub. No.: US 2010/0037317 A1
(43) Pub. Date: Feb. 11, 2010

(54) MEHTOD AND SYSTEM FOR SECURITY MONITORING OF THE INTERFACE BETWEEN A BROWSER AND AN EXTERNAL BROWSER MODULE

(76) Inventor: Jeong Wook Oh, Irvine, CA (US)

Correspondence Address: STETINA BRUNDA GARRED & BRUCKER, 75 ENTERPRISE, SUITE 250, ALISO VIEJO, CA, 92656, US

(21) Appl. No.: 12/186,681

(22) Filed: Aug. 6, 2008

(51) Int. Cl. G06F 21/00

(52) U.S. Cl. 726/23

(57) ABSTRACT

A method for detecting attacks that exploit vulnerabilities in an external module of a primary application is disclosed. The method begins with receiving from the primary application an external module method call that includes a module identifier and a module parameter. Thereafter, the external module method call is intercepted prior to the instantiation of the external module. The external module method call, which may include various data, is compared to the signature rules that are correlated to an attack attempt. If there is a match, then a resulting action part defined in the signature rule is evaluated. Otherwise, the external module is invoked.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present invention relates generally to computer data security, and more particularly, to methods and systems for security monitoring and access-controlling of the interface between a browser and an external browser module.

2. Related Art

At earlier stages in the evolution of the World Wide Web, browser applications were only capable of rendering text-only hypertext markup language (HTML) pages. Further developments in web browsers enabled the display of graphical images in-line with the text. Nevertheless, such web browsers were nothing more than static document viewers. As such, the interactivity level of the web remained low. In response to the ever-increasing need to deliver additional interactivity over the web, scripting functionality such as JavaScript and VBScript was added.

Various software developers extended the functionality of web browsers beyond basic HTML and JavaScript features with installable add-ons or external browser modules that execute system related code. One such extend functionality was the play back of multimedia content. Video, audio, animation, three-dimensional environments, Portable Document Format (PDF) documents, and the like retrieved from remote sources are rendered with such add-ons. These add-ons are binaries, as contrasted from scripts, and are downloaded from remote websites and executed locally. Popular add-ons include QuickTime from Apple Corporation, RealPlayer from RealNetworks, Inc., and Shockwave Flash from Adobe Systems, Inc. The two most popular web browsers of the present, Internet Explorer from Microsoft Corporation, and Firefox from the Mozilla Foundation, both include features for interfacing with add-ons, though specific implementation details of each differ.

Although add-ons provide valuable functionality, there is a dramatic increase in exposure to security risks. Default security settings in earlier web browsers often permitted the automatic and transparent download of add-ons, leaving the entire system vulnerable to surreptitious installations of malicious add-on software. While more stringent default security settings of conventional web browsers have mitigated the risk of hidden installations to some degree, each new add-on, regardless of legitimacy, represents another potential security vulnerability that may be leveraged by attackers to compromise the entire system and any data residing thereon.

A common attack involves passing malicious data to the legitimate add-on in an attempt to induce exploitable conditions. Add-ons are implemented as Active-X controls or Java Applets with the Internet Explorer browser and as Plugins with the Firefox browser, though both are instantiated via a script on a webpage. The instantiation is accompanied by parameter values that are passed to the add-on. For legitimate purposes, these parameters define how the add-on is executed. Attack attempts, on the other hand, attempt to pass parameter values that are not expected such as excessively long strings or large numbers, or modified file pathnames that can access data outside of a defined directory boundary. Because the add-ons run at the same privilege level as the web browser, any additional arbitrary code subsequently executed by the attacker will run at the same privilege level as the current user that executed the add-on. Usually, the attacker effectively gains free reign over the entire system, allowing the installation of various malicious software such as spyware, botnet clients, spambot network clients, keystroke loggers, and so forth.

This attack is typically not isolated, and can be conducted on a very wide scale anonymously, and are thus referred to as “drive by download” exploits. An attacker uploads a malicious HTML/scripted page and a malicious binary (spyware, botnets clients, etc.) to a remote server. This server may be owned by the attacker, owned by another party that hosts web pages for customers or by a third party, whose server has been compromised. Once these steps are complete, the attacker attempts to direct a victim to the malicious page by linking to the same on message forums, e-mails, or embedding an in-line frame within a seemingly legitimate website. Upon retrieving the malicious web page, the exploited add-on module directs the browser to download the malicious binary and execute it. Because there is a statistically high likelihood of a large installation base of the add-ons, there is a high attack success rate. Additionally, because the developers seldom update add-ons and are even more rarely updated by users, vulnerable systems may be online for an extended period of time. Furthermore, the vulnerability is likely to exist in the same add-ons installed across multiple operating systems because the implementation of the functions and interfaces will be the same.

One conventional technique for safeguarding against attacks is monitoring network traffic with hardware and software gateways. These solutions attempt to detect attack attempts based on a comparison of network data segments to predefined attack signatures, and drop any malicious data. While network monitoring is effective in preventing network-based attacks when configured properly, client-side attacks involving browser add-on exploits are difficult to stop at the network level. An improved version of a network scanner is described in U.S. Pat. App. Pub. No. 2005/0273857 by Freund that involves an attempt to analyze network traffic on a per-application basis. In further detail, the signature engine is tailored to examine network data patterns as limited to specific application vulnerabilities. As previously described, JavaScript is a primary attack modality because it provides many programming features that are leveraged to execute code within the exploit. Furthermore, JavaScript code can be obfuscated by using its own encoding methods to wrap the specific instructions of the exploit attempt, in some instances involving multiple layers of wrapping. Decoding each of these obfuscation layers at the network level to detect an exploit attempt is impossible because of the its complexity, and the attack detection can be easily evaded. As such, network monitoring techniques, regardless of the sophistication of the analysis algorithms utilized, is largely ineffective to prevent browser add-on exploits.

Another conventional technique for preventing exploits involves executing the browser add-on in a so-called “sandbox” environment, and to the extent that there is a need to access system-level functions, those Application Programming Interface (API) calls are carefully monitored to prevent access violations. U.S. Pat. No. 5,974,549 to Golan, for example, is directed to a secure sandbox within which software components can be executed. If the software component attempts to execute an instruction that violates a security policy such as reading from/writing to the file system, its execution is halted. A sandbox environment, however, requires extensive system resources because memory and processing resources must be allocated to a “virtual system.” Thus, legitimate calls to system resources are needlessly delayed, and efficiency of code execution is greatly reduced. This is particularly a problem for processing-intensive tasks such as video playback.

Instead of the focusing on the prevention of exploits of browser add-on vulnerabilities, another common approach is directed to preventing the execution of the actual malicious binary. Conventional anti-virus and anti-spyware scanners periodically search the computer system for malicious binaries, and some have memory-resident monitors that detect the execution of the same. These scanners typically rely on frequently changing signatures, and so are inherently unreliable in detecting the latest malicious software. Alternatively, only binaries known to be safe are allowed to execute. Exemplary systems taking this approach are described in U.S. Pat. App. Pub 2006/0150256 by Fanton, et al., and U.S. Pat. App. Pub. No. 2003/0188394 by Dozortsev. Both systems rely upon a central, trusted whitelist to establish execution permissions, and to the extent that such whitelists are stored and managed by the system being protected, successful exploitation of a browser add-on on such system may result in the whitelist being compromised. The sound approach is to stop the exploit attempt altogether.

Due to the severity and proliferation of browser add-on vulnerability exploits, system usability and user experience may merely be a secondary concern. Accordingly, another solution is disabling all browser add-ons. In enterprises where computer use never requires the viewing of interactive content, such a policy may be acceptable. However, for home computer users and the vast majority of enterprises, disabling all add-ons is too restrictive.

Accordingly, there is a need in the art for a method and system for security monitoring of the interface between a browser and an external browser module.

### BRIEF SUMMARY

According to one aspect of the present invention, there is disclosed a method for detecting attacks exploiting vulnerabilities in an external module of a primary application. The method may begin with receiving from the primary application an external module method call that may include a module identifier and a module parameter. The external module method call may be incorporated in a malicious data transmission representative of an attack attempt. The method may also include the step of intercepting the external module method call prior to instantiation of the external module. Further, the method may include comparing the external module method call to predetermined signature rules. Such signature rules may be stored in a database, with a first given one of the predetermined signature rules having a module identifier part, a module parameter part, and a resulting action part. The module parameter part can be correlated to an attack attempt that relates to a potential vulnerability in the external module. This external module may be designated by the corresponding module identifier part. The method may also include evaluating the resulting action part in response to an affirmative comparison between the external module method call and the first one of the predetermined signature rules.

In another embodiment of the present invention, there is provided a method for securing external applications called by a web browser. The method may include retrieving a potentially malicious webpage containing an external application instantiation command. The webpage may also contain parameters for the external application instantiation command. Furthermore, the method may include the step of intercepting the external application instantiation command prior to it reaching the external application. The method may include evaluating the parameters from the potentially malicious webpage against signature rules stored in a database. This evaluation may be started upon interception of the external application instantiation command. According another aspect, the signature rules may each define a particular set of conditions of the parameters corresponding to an exploit attempt and a predefined action. The method may conclude with performing the function set in the predefined action.

In yet another embodiment of the present invention, an endpoint security system for detecting and preventing attacks directed through an external module of a primary application is provided. The system may include a database with attack signatures stored thereon. The attack signatures may include an external module identifier and a set of external module parameter checks that are characteristic of an attack attempt. Additionally, the system may include a monitoring component installable in an interface between the external module and the primary application. This monitoring component is operative to intercept an external module method call from the primary application. The system may also include a rule processing engine in communication with the database. The rule processing engine can compare the intercepted external module method call to the attack signatures, and invoke a rule action upon a match of the intercepted external module method call to one of the attack signatures.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a block diagram illustrating the basic components of an exemplary hardware environment in which aspects of the present invention may be implemented;

FIG. 2 is a block diagram of the various software components in which aspects of the present invention may be implemented including an operating system and its various components in relation to the hardware and user applications;

FIG. 3 is a block diagram of an exemplary Component Object Model (COM) interface defining a web browser architecture with additional functionality being provided via an external module;

FIG. 4 is a block diagram illustrating the functional relationship between the web browser and the external module;

FIG. 5 is a flow diagram of an exemplary exploit of a vulnerability in the external module;

FIG. 6 is a listing of HTML, JavaScript, and VBScript code corresponding to the exploit of the vulnerability in the external module;

FIG. 7 is a flowchart showing a method for detecting attacks exploiting vulnerabilities in the external module of a primary application or web browser in accordance with one aspect of the present invention;

FIG. 8 is a block diagram of an endpoint security system according to one embodiment of the present invention;

FIG. 9 is a diagram illustrating the various relationships between types of module parameters;

FIG. 10 is an exemplary signature rule utilized in evaluating an external module method call for potential attacks; and

FIG. 11 is an exemplary COM client-server infrastructure in accordance with one embodiment of the present invention.

Common reference numerals are used throughout the drawings and the detailed description to indicate the same elements.

### DETAILED DESCRIPTION

The detailed description set forth below in connection with the appended drawings is intended as a description of one presently preferred embodiment of the invention, and is not intended to represent the only form in which the present invention may be developed or utilized. The description sets forth the functions of the invention in connection with the illustrated embodiment. It is to be understood, however, that the same or equivalent functions may be accomplished by different embodiments that are also intended to be encompassed within the scope of the invention. It is further understood that the use of relational terms such as first and second and the like are used solely to distinguish one from another entity without necessarily requiring or implying any actual such relationship or order between such entities.

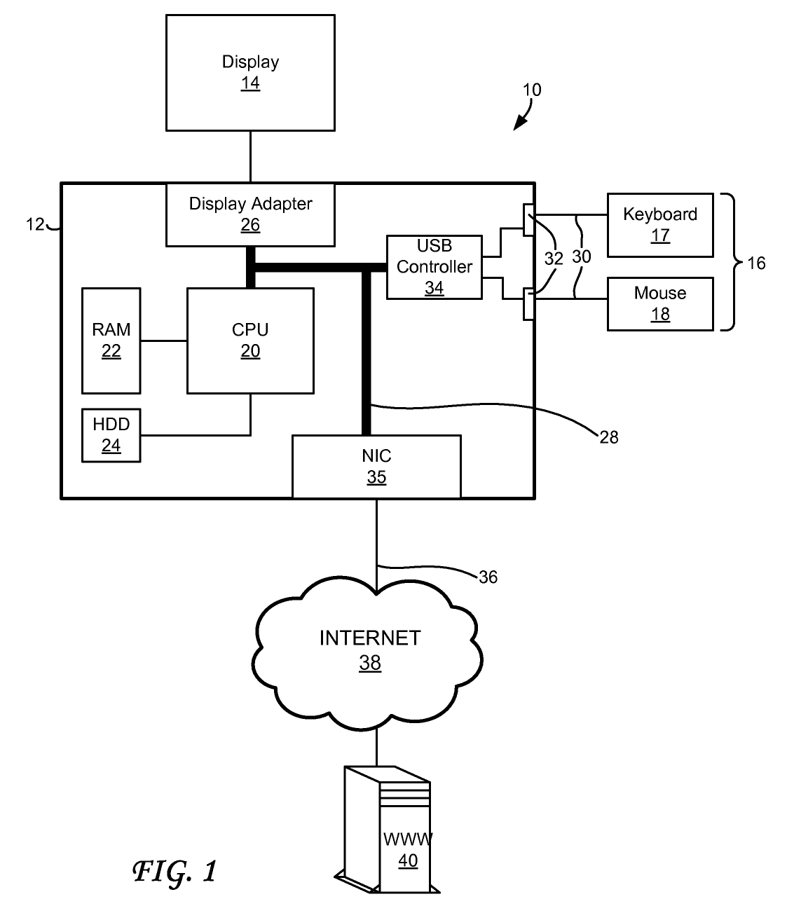

With reference to the block diagram of FIG. 1, an exemplary hardware environment in which aspects of the present invention may be implemented includes a general purpose computer system 10 comprised of a system unit 12, a display 14, and input devices 16 including a keyboard 17 and a mouse 18. The system unit 12 includes a central processing unit(s) (CPU) 20 coupled to a random access memory (RAM) 22 and a hard disk drive (HDD) 24 that temporarily and permanently, respectively, store executable code and data processed by the CPU 20. The display 14 is connected to the system unit 12 via a display adapter 26 coupled to the CPU 20 over an input/output (I/O) bus 28, and graphically shows the output from data processing operations. As is common in conventional computer systems, the input devices 16 communicate with the system unit 12 over a Universal Serial Bus (USB) link 30 connected to USB ports 32. The connections are managed by a USB controller 34 that is coupled to the CPU 20 over the I/O bus 28.

The computer system 10 includes a network interface 35 for communicating with other systems over a network connection 36. The network interface 35 may conform to any one of widely used network standards such as Ethernet, 802.11x wireless, Bluetooth, or the like. The network connection 36 may provide a link to the Internet 38, in which case the network connection 36 may be a Cable Internet, Digital Subscriber Line (DSL), or other like wide area network commonly utilized to provide Internet connections to end users. As will be described in further detail below, the computer system 10 may establish a connection with a server 40 over the Internet 38 to conduct data transfer operations. The exemplary server 40 may be a web server communicating over the Hyper Text Transfer Protocol (HTTP) to transmit a variety of data stored thereon to the computer system 10.

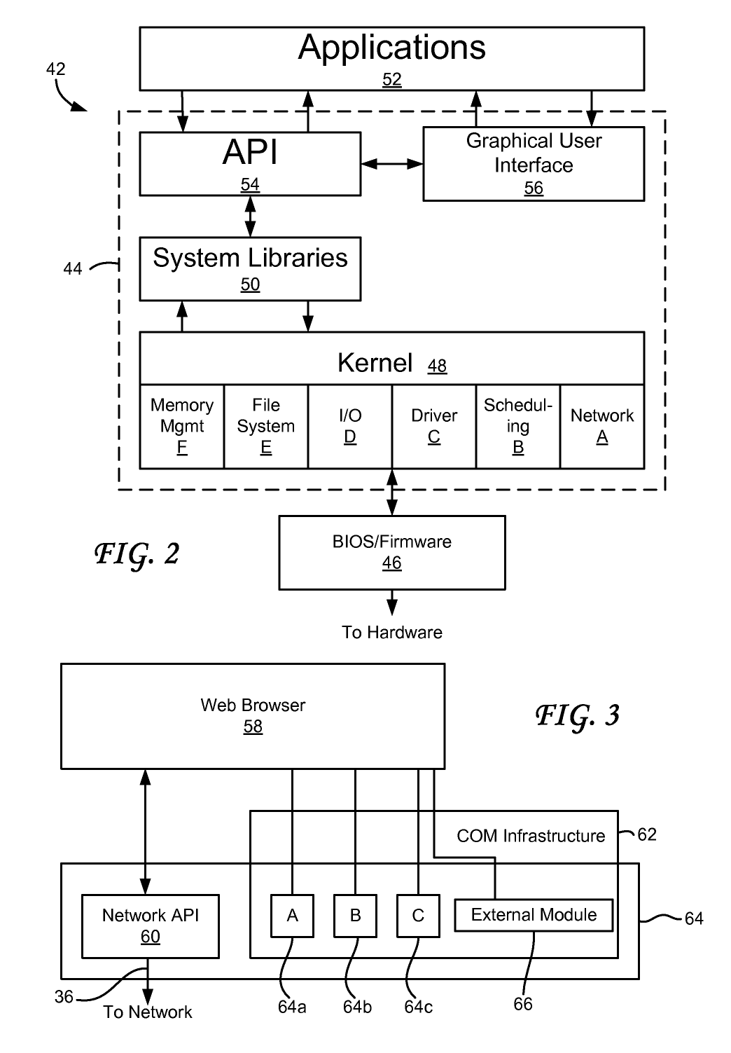

As shown in FIG. 2, a logical representation of a software system 42 running on the computer system 10 is shown. An operating system 44 interfaces with a Basic Input Output System (BIOS) firmware 46 to control the various hardware devices of the computer system 12, and directs the overall data processing functions of the same. Specifically, the operating system 44 includes a kernel 48 having various system management components including a networking module 48a, a process scheduling module 48b, hardware drivers 48c, an input/output module 48d, a file system module 48e, and a memory management module 48f. System libraries 50, which are also part of the operating system 44, provide basic “building block” functionality to application software 52, the implementation details thereof being abstracted with application programming interfaces (APIs). Many operating systems have an integrated graphical user interface 56 through which a user can interact with the computer system 10 and the applications 52, though some have windowing systems completely independent of the operating system 44.

One common operating system with a wide installation base is Windows from Microsoft Corporation, and one embodiment of the present invention contemplates an implementation thereon. It will be recognized by those having ordinary skill in the art, however, that any other operating system may be utilized. Along these lines, the foregoing computer system 10 represents only one exemplary apparatus suitable for implementing aspects of the present invention. As such, the computer system 10 may have many different configurations and architectures, and any such alternative configuration or architecture may be readily substituted without departing from the scope of the present invention.

Referring now to FIG. 3, a web browser 58 is installed on the software system 44, and is understood to be one kind of application software 52 that interacts with the operating system in the same way as any generic application described above. It is contemplated that the web browser 58 be of any variety, though in one embodiment of the present invention, it is Internet Explorer. With further reference back to FIG. 1, the web browser 58 communicates with a network API 60 to initiate a data transfer link over the network connection 36 to the server 40. In this regard, the network API 60 is understood to be one of the APIs 54 of the operating system 44. One of ordinary skill in the art will recognize that a request for a particular page is made through the web browser 58 in the form of a Uniform Resource Locator (URL) address over HTTP. The URL can be inputted by the user, or be specified via a selection of a hyperlink to that URL. Upon receiving the request, the server 40 transmits the requested page, which is typically an HTML file, and is rendered or otherwise processed by the web browser 58 for the user.

One embodiment of the present invention is envisioned as being implemented on the Windows operating system, as indicated above. The operating system 44 includes a Component Object Model (COM) infrastructure 62, which provides a framework for object reuse and inter-process communications between objects. The COM infrastructure 62 provides a variety of individual software components or objects that each has a specific and limited set of functions. The COM objects may, in turn, be combined to build full-featured applications. As shown in FIG. 3, one type of COM object is an ActiveX control 64, which is intended for applications that are executed through the web browser 58. In this regard, the ActiveX control may be referred to as a COM server, and the web browser 58 may be referred to as a COM client.

As will be described in further detail below, the Internet Explorer web browser allows ActiveX controls to be embedded within web pages. Each ActiveX control 64a-c may be called by the web browser 58, and each one has an unique interface thereto. By way of example, another ActiveX control, referred to as external module 66, may be a separately developed application such as a video playback add-on to the web browser 58. It is understood that multiple external modules 66 may be installed and called by a single instance of the web browser 58. Alternative embodiments of the present invention contemplate implementations for other web browsers and operating systems, and those having ordinary skill in the art will understand that the specific programming necessary for such embodiments will differ due to the differences in the system environment compared to the COM/ActiveX/Internet Explorer environment described above. When using other operating systems that do not have the COM infrastructure 62 or other web browsers besides Internet Explorer that are incapable of communicating with the COM infrastructure 62, external modules that provide additional functionality to the web browser 58 may be implemented as Java applets, independent browser plugins binaries, or the like. Along these lines, it is to be understood that the term external module 66 refers generally to browser add-ons, browser plugins, applets, or any other executable code that interfaces with a primary application such as the web browser 58 and not interpreted therewith (as with JavaScript code). While aspects of the present invention will be described in detail in the context of the aforementioned COM/ActiveX/Internet Explorer environment, it will be appreciated that such details are presented by way of example only and not of limitation.

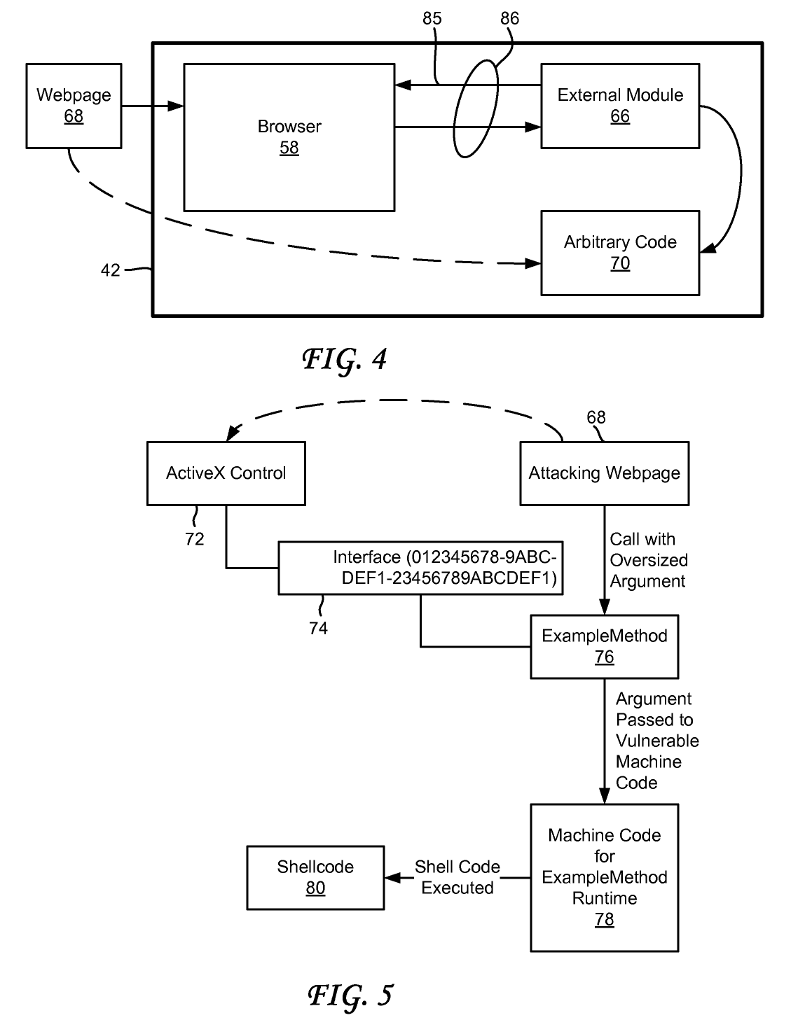

The block diagram of FIG. 4 illustrates a more general view of the functional relationship between the web browser 58 and the external module 66. In particular, the web browser 58 retrieves a web page 68 containing scripted instructions that are operable to invoke methods associated with the external module 66, and renders the same. During the rendering stage, the script is executed and the methods of the external module 66 are called. The script may set additional properties or variables that define the scope of operation of the methods of the external module 66. Continuing with the video playback example, one of the variables that may be passed is the URL of the video file to be loaded. The output from the methods of the external module 66 are displayed in a user interface of the web browser 58. As briefly explained in the background, the security of the software system 42 is potentially compromised when the web page 68 contains a malicious script that exploits a vulnerability in the external module 66 that permits arbitrary code 70 to be executed. The most common vulnerabilities are buffer overflow, integer overflow, and data manipulations. The arbitrary code 70 is typically injected into the memory space of external module 66, and a pointer to the beginning instruction of the arbitrary code 70 is set.

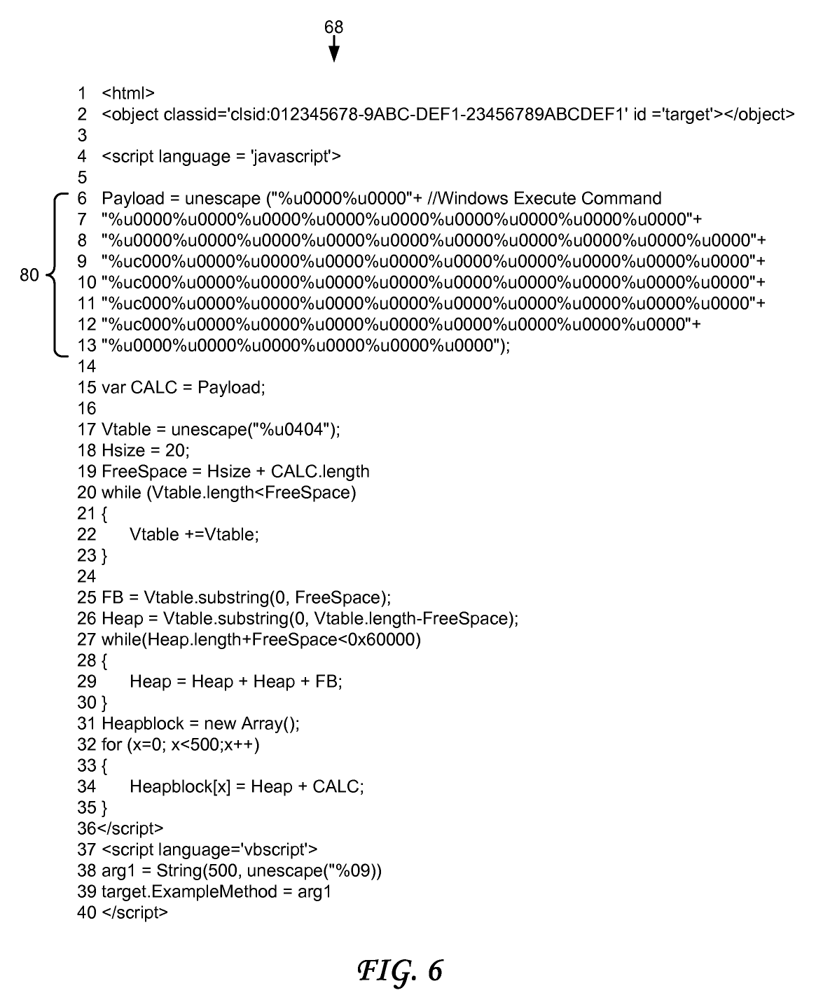

The flow diagram of FIG. 5 and the code listing of FIG. 6 depict an example buffer overflow vulnerability exploit. An attacking webpage 68 is an HTML file as indicated by the header in line 1 of the code listing. Additionally, the attacking webpage 68 includes JavaScript code between line 4 and line 36 of the code listing, as well as VBScript code between line 37 and line 40 of the code listing. While the script code of the attacking webpage 68 is shown in plaintext, in some circumstances, it may be obfuscated in multiple layers to prevent immediate recognition by network-level filters. Line 2 of the code listing instantiates an ActiveX control 72 with a specified “classid” 74. The exploited vulnerability in the ActiveX control 72 is the lacking boundary check in the “ExampleMethod” method 76. The first argument passed to the ExampleMethod method 76 is an oversized string as set forth in line 38 of the code listing. Here, a string 500 bytes long is passed along with a call to the ExampleMethod method 76 as shown in line 39 of the code listing. This results in a buffer overflow condition allowing the execution 78 of shellcode 80. Line 6 through Line 13 of the code listing contains text-encoded machine language instructions corresponding to the shellcode 80. Malicious shellcode 80 can initiate the download and execution of malware.

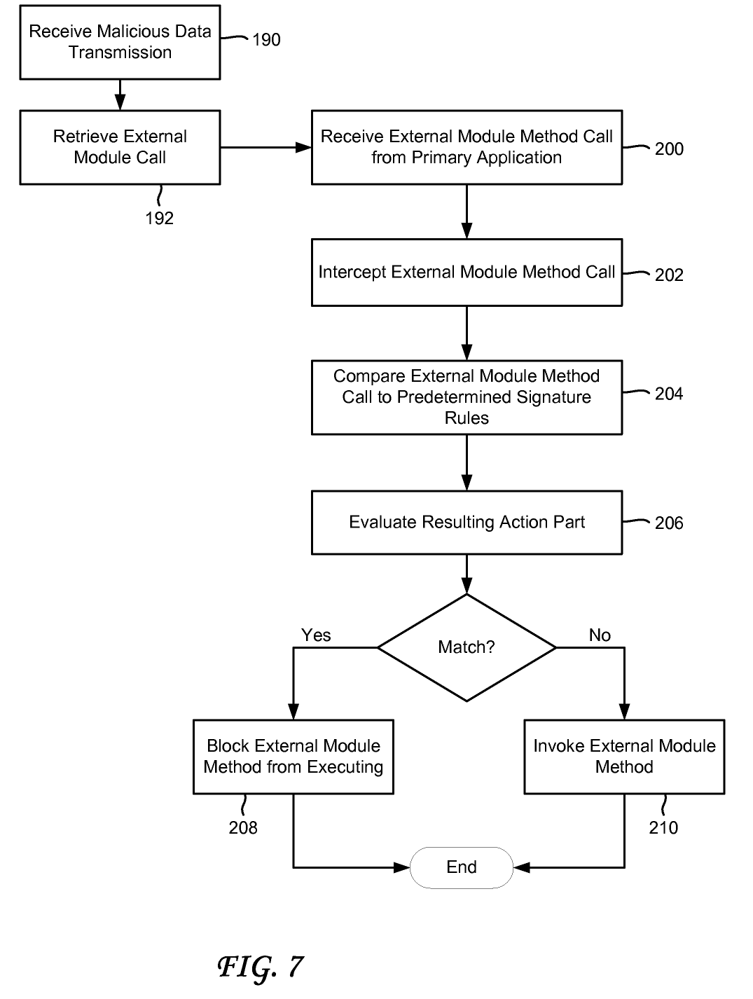

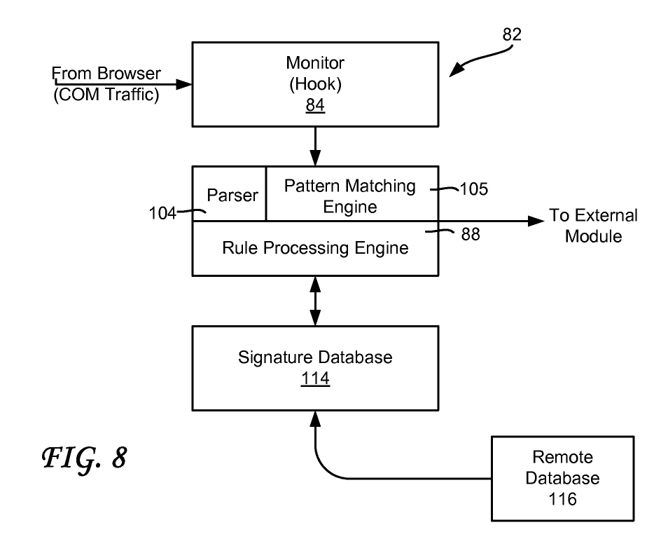

Aspects of the present invention are directed to preventing the type of attack described above. Referring to the flowchart of FIG. 7, one embodiment of the present invention contemplates a method for detecting attacks that exploit vulnerabilities in the external module 66 of a primary application or web browser 58. Another embodiment illustrated in FIG. 8 envisions an endpoint security system for detecting and preventing attacks directed through the external module 66 of the primary application or web browser 58. Further details of both embodiments will be described more extensively below.

Referring additionally to FIG. 4, the method for detecting attacks begins with a step 200 of receiving an external module method call 85 from the primary application or web browser 58. Step 200 may be preceded by receipt of a malicious data transmission such as the web page 68 by the primary application from an attack source according to step 190 and as detailed in the example above. The external module method call 85 may be incorporated into the malicious data transmission that is representative of an attack attempt. It is understood that in the context of the COM/ActiveX/Internet Explorer environment, one aspect of the external module method call 85 refers to a process of instantiating a new ActiveX control, that is, the external module 66. The specific modality by which the process is started may be referred to as an external application instantiation command.

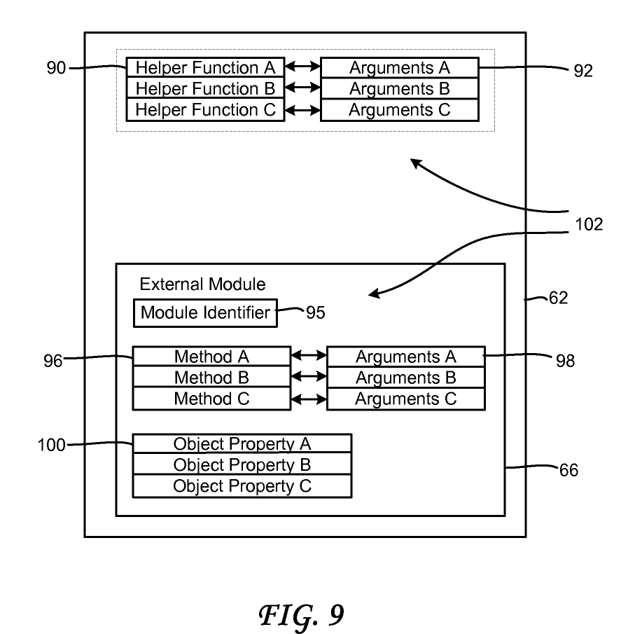

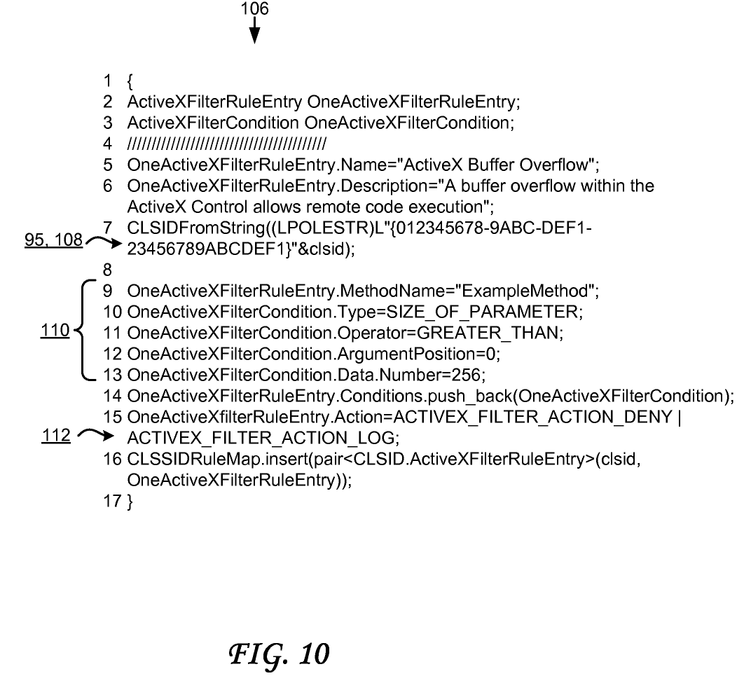

The external module method call 85 is also understood to encompass a variety of data and subroutines, detailed more fully hereinafter. As best illustrated in FIG. 9, the COM infrastructure 62 defines helper functions 90, each with one or more global method arguments 92 with values that set the operational parameters of the respective global method. In general, it is understood that the helper functions 90 implement general housekeeping functions such as instantiation and destruction of new COM components. As described above, the COM infrastructure 62 is connected to the external module 66. A module identifier 95 such as the specific classid 74 described above allows for a number of different external modules to be differentiated from each other. The external module 66 also provides external module methods 96 and external module method arguments 98, the values therefor setting the operational parameters of the respective external module method. Within the external module 66, there are module object properties 100, the scope of which are limited to the external module 66. Based on conventional object oriented programming principles, the external module methods 96 have access to the helper functions 90 and associated arguments 92. All of the foregoing properties and method identifiers are generally referred to as module method parameters 102, and an anomaly with respect to any may open an exploitable vulnerability.

Referring back to FIG. 7, according to step 202, the method continues with intercepting the external module method call prior to the actual execution of the method of the external module 66. With reference to FIGS. 4 and 8, the endpoint security system 82 includes a monitoring component 84 that is injectable into an interface 86 between the external module 66 and the primary application or web browser 58. It is expressly contemplated that the monitoring component 84 intercepts any external module method calls 85 before reaching the external module 66. Although FIG. 4 illustrates the logical location of the interface 86 upon which the monitoring component 84 is disposed, in the COM/ActiveX/Internet Explorer environment, one embodiment contemplates loading the monitoring component 84 into the same memory space as the primary application or web browser 58. Upon being directed to do so, the monitoring component 84 retrieves some or all of the module method parameters 102 for subsequent evaluation, a process that will be described more fully below. Essentially, the inter-process communications over the COM infrastructure 62 between the web browser 58 and the external module 66 are reviewed. In further detail, hooks are installed in the COM infrastructure 62 that redirects any external module method calls, and specifically the external module instantiation commands, to the monitoring component 84.

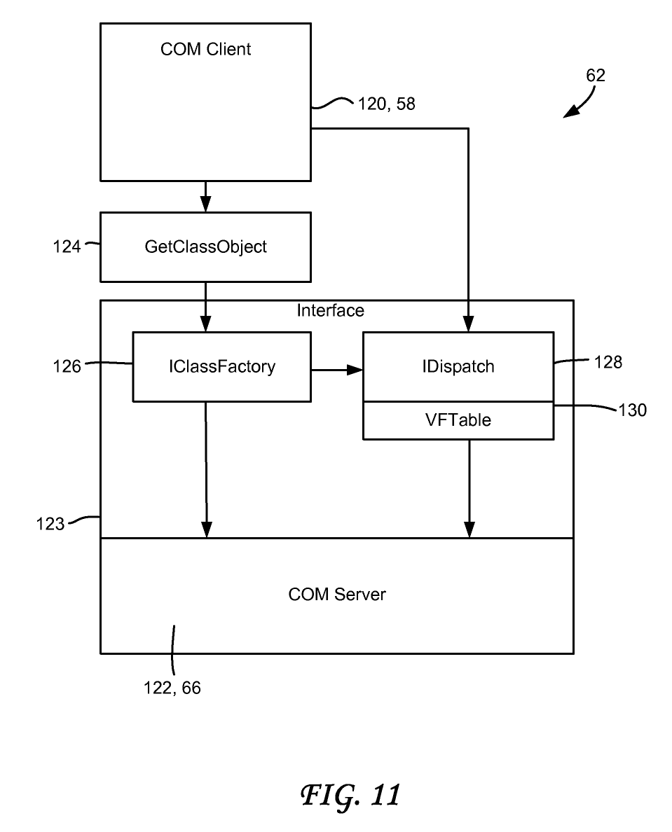

As is understood, the COM infrastructure 62 is modeled after a client-server environment. With reference to the diagram of FIG. 11, a COM client 120 is understood to be the browser 58, while a COM server 122 is the external module 66. The COM server 122 exposes interfaces 123 to the COM client 120. Generally, a GetClassObject API 124 can be used to access the interfaces 123, specifically via the IClassFactory interface 126, which is used to generate instances of the COM class. Generally, ActiveX controls are reusable components that implement the IDispatch interface 128, which allows any object to be queried for a list of pointers to other interfaces supported by the object. As will be recognized by those having ordinary skill in the art, the IDispatch interface 128 provides the COM client 120 the functionality to call COM server methods by strings, which can be used by scripting languages as described above.

As indicated above, the monitor 84 is logically located between the external module 66 or the COM server 122, and the web browser 58 or the COM client 120. In particular, a GetClassObject hook is installed via in-line hooking, or any other type of hooking. The GetClassObject hook retrieves the IClassFactory interface 126, which is used to create the IDispatch interface 128. As will be appreciated by those having ordinary skill in the art, the virtual table associated with the IDispatch interface 128 will be shared with any newly created instances thereof. By hooking the invoke method associated with the IDispatch interface 128, any method calls thereof can be controlled.

The invoke methods of the IDispatch interface 128 are intercepted by the monitor 84. A virtual method table 130 associated with the IDispatch interface 128 modifies the pointer to the invoke method to an invoke hook method, which is capable of accessing all parameters destined for the original invoke method call. Additionally, the pointer in the virtual method table 130 is accessible by the invoke hook method, and a call to any method in the IDispatch interface 128 is possible. Certain IDispatch methods such as GetTypeInfoCount and GetTypeInfo can be utilized to retrieve the name and parameter types for all of the exposed methods of the COM client 120.

Although the details of a specific feature for intercepting the external module method calls 85 has been described, those having ordinary skill in the art will recognize that other instruction jumping techniques are possible, particularly in relation to other environments besides the COM infrastructure 62; substitution of any such other techniques is expressly envisioned to be within the scope of the present invention.

Referring again to the flowchart of FIG. 7, the method in accordance with one embodiment of the present invention continues with a step 204 of comparing the external module method call 85 to predetermined signature rules. In further detail as best illustrated in FIG. 8, a rule processing engine 88 is called by the monitor component 84 to evaluate the module method parameters 102 derived from the external module method call 85. The rule processing engine 88 includes a memory parser 104 that analyzes the memory space of the web browser 58, and retrieves the individual components of the external module method call 85. In one embodiment, each of the module method parameters 102 are retrieved by the memory parser 104.

As shown in FIG. 10, the example rule signature 106 has various parts that define known characteristics of vulnerability exploits for the external module 66. In accordance with one embodiment of the present invention, the rule signature 106 begins with a self-instantiation in line 2 and line 3, and continues with various properties being set through assignment operators. The “Name” property of the class “ActiveXFilterRuleEntry” shown in line 5 defines the name of the rule signature 106 for identification purposes, and as such, can be set to be descriptive of the exploit vulnerability it patches. The “Description” property of the class “ActiveXFilterRuleEntry” in Line 6 provides additional details regarding the exploit, and line 7 specifies the particular external module 66 to which the rule signature 106 applies with the module identifier 95. As such, line 7 may be referred to as a module identifier part 108 of the rule signature 106.

The “ActiveXFilterCondition” class that is shown in line 9 through line 13 specify the various conditions that must be met by the module method parameters 102 in order to detect an exploit attempt, and is referred to as a module method parameter part 110 of the rule signature 106. The particular example of the rule signature 106 shown in FIG. 10 is understood to protect against the same attack shown in FIG. 5 as embodied in the malicious web page 68 of FIG. 6. In this regard, the module identifier part 108 is equivalent to the specific classid 74 in line 2 of the malicious webpage 68. Because the exploit involves the particular “ExampleMethod” method 76, the “MethodName” property of the “ActiveXFilterCondition” class holds the same value as shown in line 9. The type of condition that results in a successful exploit is the excessive length of an input string, so the “Type” property of the “ActiveXFilterCondition” class listed in line 10 indicates “SIZE_OF_PARAMETER”. It is contemplated that other condition types may be specified, such as a range of integers, regular expressions, elementary string matches, wildcard matches, and so forth. Corresponding modifications can be made to the “Operator” property of the “ActiveXFilterCondition” class listed in line 11 in order to handle such alternative condition types. Considering methods may accept one or more arguments that specify operational bounds of the method. The “ArgumentPosition” property of the “ActiveXFilterCondition” class shown in line 12 may be used to limit the relative position of the method argument to be analyzed. With the various operator properties set, the operands therefor may be specified via the “Data” property of the “ActiveXFilterCondition” class in line 13. Various kinds of the “Data” property are contemplated, including “Number,” “String” and other commonly used data types.

The foregoing comparison and matching operators may be implemented in a pattern matching engine 105. Additionally, the pattern matching engine 105 may include a regular expression evaluator for parsing the module method parameter part 110, which may be written as a regular expression. As will be appreciated, regular expressions are particularly useful for matching complex string patterns, which is a frequently encountered issue in heuristic and signature-based analyses.

While the above-described exemplary rule signature 106 is tailored for a particular vulnerability in a method of a particular external module 66, it is also contemplated that some other rule signatures may be specified generically as being applicable to one or more other external modules where such modules all have the same vulnerability. One implementation of such a generic signature may include a module identifier part that corresponds to a plurality of external modules. By way of example only and not of limitation, ActiveX controls may be disabled from accessing domains other than the domain making the request, executables may be prohibited from being passed into ActiveX controls, and all string inputs may be limited to less than 500 characters.

Another aspect of the present invention contemplates the analysis of data formats and the use of rule signatures therefor. For example, an argument to a method in an ActiveX control may expect only text data, or expect only video data, or the like. For such requirements, the data being passed to the method may be verified to conform to the specified formats, and exclude data in all other formats.

With reference to the flowchart of FIG. 7 and the exemplary signature rule 106 of FIG. 10, following the comparison step 204, the method continues with a step 206 of evaluating a resulting action part 112 if there is an affirmative comparison between the module method parameters 102 of the external module method call 85 and a given one of the signature rules 106. It will be understood that the term “affirmative comparison” refers to a positive match between two strings, a true result in a comparison involving Boolean or relative operators, a regular expression match, and so forth. Essentially, if the analyzed module method parameters 102 fit the characteristics of an exploit attempt, then the actions defined in the signature rule 106 are performed. As shown in line 15 of the exemplary signature rule 106, “ACTIVEX_FILTER_ACTION_DENY” and “ACTIVEX_FILTER_ACTION_LOG” are assigned to the property “Action” of the “ActiveXFilterRuleEntry” class. Thus, the external module method call 85 is blocked from reaching the external module 66 according to step 208, and the exploit attempt is logged. If there is a negative comparison, that is, the module method parameters 102 do not satisfy any one signature rule 106, then the external module method call 85 is permitted to reach the external module 66 according to step 210.

As shown in the block diagram of FIG. 8, the signature rules 106 are stored in a signature database 114 in one embodiment of the present invention. The signature database 114 is in communication with the rule processing engine 88 for the retrieval of the rule signatures 106 for use in the comparison step 204. It is understood that the signature database 114 may be of any suitable configuration, and may be as simple as a flat, text-based file depicted in FIG. 10, or a sophisticated Structured Query Language (SQL)-type database with advanced query features. As will be recognized by those having ordinary skill in the art, the number of signature rules stored and the complexity of the individual signature rules necessitating superior querying functions will guide such a determination. Due to the proliferation of a large number of exploitable vulnerabilities, the signature database 114 is also configured to connect to a central remote database 116 so that the latest signature rules can be downloaded therefrom.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

What is claimed is:

1. A method for detecting attacks exploiting vulnerabilities in an external module of a primary application, comprising:
receiving from the primary application an external module method call including a module identifier and a module parameter, the external module method call being incorporated in a malicious data transmission representative of an attack attempt;
intercepting the external module method call prior to instantiation of the external module;
comparing the external module method call to predetermined signature rules stored in a database, a first given one of the predetermined signature rules having a module identifier part, a module parameter part, and a resulting action part, the module parameter part being correlated to an attack attempt related to a potential vulnerability in the external module designated by the corresponding module identifier part; and
evaluating the resulting action part in response to an affirmative comparison between the external module method call and the first one of the predetermined signature rules.

2. The method of claim 1, wherein prior to receiving the external module method call, the method further includes:
receiving the malicious data transmission by the primary application from an attacking source; and
retrieving the external module method call from the malicious data transmission.

3. The method of claim 1, wherein the resulting action part includes a command to block the transmission of the external module method call to the external module.

4. The method of claim 1, wherein the resulting action part includes a command to transmit the external module method call to the external module in response to a negative comparison between the module parameter and each of the predetermined signature rules in the database, the method further comprising:
invoking the external module according to the module parameters in the external module method call.

5. The method of claim 1, wherein a second given one of the predetermined signature rules has a generic module identifier part corresponding to a plurality of known external modules, the module parameter part corresponding thereto being associated with a known attack attempt targeting a potential vulnerability in the plurality of known external modules.

6. The method of claim 1, wherein the module parameter part of the predetermined signature rules includes a suspicious parameter format and a suspicious parameter value.

7. The method of claim 6, wherein the comparing step further includes:
assessing a format of the module parameter of the external module method call against the suspicious parameter format for a match to attack characteristics.

8. The method of claim 6, wherein the comparing step further includes:
assessing a value of the module parameter of the external module method call against the suspicious parameter value for a match to attack characteristics.

9. The method of claim 1, wherein the module parameter includes global properties accessible by a plurality of external modules.

10. The method of claim 1, wherein the module parameter includes an identification of module functions accessible from the primary application.

11. The method of claim 10, wherein the module parameters includes local function properties accessible by the module functions associated therewith.

12. The method of claim 1, wherein the module parameters include function arguments and corresponding values passed specifically to a one of the module functions.

13. The method of claim 1, wherein the module parameter part of the predetermined signature rule includes an operator definition for the comparing step.

14. The method of claim 1, wherein the primary application is a world wide web browser.

15. The method of claim 1, wherein the attack attempt targets a vulnerability selected from a group consisting of: buffer overflow, integer overflow, and data manipulation.

16. The method of claim 1, further comprising:
retrieving an updated signature rule from a remote database; and
storing the updated signature rule in the local database.

17. A method for securing external applications called by a web browser, comprising:
retrieving a potentially malicious webpage containing an external application instantiation command and parameters therefor;
intercepting the external application instantiation command prior to reaching the external application;
evaluating the parameters from the potentially malicious webpage against signature rules stored in a database upon interception of the external application instantiation command, the signature rules each defining a particular set of conditions of the parameters corresponding to an exploit attempt and a predefined action; and
performing the function set in the predefined action.

18. The method of claim 17, wherein the function set in the predefined action includes:
preventing the execution of the external module in response to an affirmative comparison to the parameters and the set of conditions defined by a one of the signature rules.

19. The method of claim 17, wherein the function set in the predefined action includes:
instantiating the external module in response to a negative comparison of the parameters of the set of conditions defined by each of the signature rules in the database.

20. The method of claim 17, wherein the evaluating step further includes:
deriving the identity of the called external application from the external application instantiation command, the identity of the called external application being a one of the set of conditions corresponding to the exploit attempt.

21. The method of claim 17, wherein the evaluating step further includes:
deriving from the parameters instantiation properties and associated values set as inputs to the external application, the instantiation properties and associated values being a one of the set of conditions corresponding to the exploit attempt.

22. The method of claim 17, wherein the evaluating step further includes:
deriving from the parameters identities of external application subroutines invoked by the web browser, the identities of external application subroutines being a one of the set of conditions corresponding to the exploit attempt.

23. The method of claim 17, wherein the evaluating step further includes:
deriving from the parameters subroutine arguments and associated values to the external application subroutines invoked by the web browser, the subroutine arguments and values being a one of the set of conditions corresponding to the exploit attempt.

24. The method of claim 17 wherein the external application instantiation command and the parameters are obfuscated in the potentially malicious webpage.

25. An endpoint security system for detecting and preventing attacks directed through an external module of a primary application, comprising:
a database with attack signatures stored thereon, the attack signatures including an external module identifier and a set of external module parameter checks characteristic of an attack attempt;
a monitoring component installable in an interface between the external module and the primary application for interception of an external module method call from the primary application; and
a rule processing engine in communication with the database for comparison of the intercepted external module method call to the attack signatures, a rule action being invoked by the rule processing engine upon a match of the intercepted external module method call to one of the attack signatures.

26. The system of claim 25, wherein the rule processing engine further includes:
a memory parser for retrieving the components of the external module method call.

27. The system of claim 25, wherein the rule processing engine further includes:
a regular expression evaluator for parsing attack signatures defined by a regular expression pattern.

28. The system of claim 25, wherein:
the primary application and the external module communicate via an inter-process communications framework; and
the monitoring component is loaded in the memory address space of the primary application and examines the external module parameters as stored therein upon invocation by the external module method call.

29. The system of claim 25, wherein the primary application is a world wide web browser.

30. The system of claim 25, wherein the external module is an ActiveX control called by the world wide web browser.

31. The method of claim 25, wherein the external module is a Java component called by the world wide web browser.

32. The method of claim 25, wherein the external module is a Mozilla plugin called by the world wide web browser.

33. A computer readable medium having computer-executable instructions for performing a method for detecting attacks exploiting vulnerabilities in an external module of a primary application, comprising:
receiving from the primary application an external module method call including a module identifier and a module parameter, the external module method call being incorporated in a malicious data transmission representative of an attack attempt;
intercepting the external module method call prior to instantiation of the external module;
comparing the external module method call to predetermined signature rules stored in a database, a first given one of the predetermined signature rules having a module identifier part, a module parameter part, and a resulting action part, the module parameter part being correlated to an attack attempt related to a potential vulnerability in the external module designated by the corresponding module identifier part; and
evaluating the resulting action part in response to an affirmative comparison between the external module method call and the first one of the predetermined signature rules.
